(19) United States
(12) Patent Application Publication
(10) Pub. No.: US 2015/0116341 A1
(43) Pub. Date: Apr. 30, 2015

(54) Display Device, and Method for Adjusting Display Device

(71) Applicant: NEC Display Solutions, Ltd., Minato-ku, Tokyo (JP)

(72) Inventors: Isamu Kenmochi, Tokyo (JP); Hiroyuki Kasuga, Tokyo (JP); Yoshihiko Shiotani, Tokyo (JP)

(21) Appl. No.: 14/408,264

(22) PCT Filed: Jun. 7, 2013
(86) PCT No.: PCT/JP2013/065883

§ 371 Date: Dec. 15, 2014

(30) Foreign Application Priority Data
Jun. 18, 2012 (JP) PCT/JP2012/065554

(51) Int. Cl. G09G 5/399

(52) U.S. Cl. CPC G09G 5/399; G09G 2320/06; G09G 2330/021
USPC 345/536

(57) ABSTRACT

A display device includes a first storage unit that stores first adjusted values; a second storage unit that stores second adjusted values; and a control unit that determines, while power of the display device is on, whether or not a predetermined specific condition has been set, where if the specific condition has been set, the control unit executes a process of writing the first adjusted values stored in the first storage unit to the second storage unit according to the specific condition so as to switch the adjusted values pertaining to individual units of the display device to the first adjusted values.

### TECHNICAL FIELD

The present invention relates to a display device whose individual parts are adjustable, and a method for adjusting a display device.

Priority is claimed on International Application No. PCT/JP2012/65554, filed Jun. 18, 2012, the contents of which are incorporated herein by reference.

### BACKGROUND ART

Display devices have various adjustment items such as sharpness, brightness, hue, and the like. As disclosed in Patent Document 1, values of such various adjustment items can be voluntarily set and changed. In addition, recommended values for the adjustment items are stored as default values during factory adjustment. After the adjustment items are set to values adjusted by the user, they can be returned to the default values.

### PRIOR ART DOCUMENT

### Patent Document

Patent Document 1: Japanese Unexamined Patent Application, First Publication No. H06-348245.

### DISCLOSURE OF INVENTION

### Problem to be Solved by the Invention

As described above, a function is applied to the various adjustment items, by which the user can voluntarily set and change them and the user set values can be returned to the default values set in the factory adjustment. However, no function has been implemented to set the values to manager adjusted values utilized for users to have a common environment and to return the user adjusted values to the manager adjusted values.

That is, in a display device introduced to a company or a school, it is preferable for a manager to collectively manage various adjustment items so as to provide a common environment over the entire company or school. However, such values adjusted by the manager are not always convenient for every user. Therefore, it is also preferable for each user to be able to reset the adjusted values. Additionally, in most cases, such a display device is commonly used among employees or students. Therefore, it is further preferable to be able to restore the manager adjusted values from the values adjusted by any user via a simple operation.

In light of the above circumstances, an object of the present invention is to provide a display device and a method for adjusting a display device, by which both manager adjusted values utilized to provide a common environment to every user and user adjusted values according to the preference of each user can be set and the manager adjusted values can be easily restored from the user adjusted values by a simple operation.

### Means for Solving the Problem

In consideration of the above problem, the present invention provides a display device comprising:
a first storage unit that stores first adjusted values;
a second storage unit that stores second adjusted values; and
a control unit that determines, while power of the display device is on, whether or not a predetermined specific condition has been set, where if the specific condition has been set, the control unit executes a process of writing the first adjusted values stored in the first storage unit to the second storage unit according to the specific condition so as to switch the adjusted values pertaining to individual units of the display device to the first adjusted values.

The present invention also provides a method of adjusting a display device, the method comprising:
a step that stores first adjusted values in a first storage unit;
a step that stores second adjusted values in a second storage unit; and
a step that determines, while power of the display device is on, whether or not a predetermined specific condition has been set, where if the specific condition has been set, the control step executes a process of writing the first adjusted values stored in the first storage unit to the second storage unit according to the specific condition so as to switch the adjusted values pertaining to individual steps of the display device to the first adjusted values.

### Effect of the Invention

In accordance with the present invention, first adjusted values utilized to provide a common environment to users can be set by storing the first adjusted values in the first storage unit. In addition, second adjusted values according to the preference of each user can be set by storing the second adjusted values in the second storage unit. Furthermore, the present invention makes it possible to write the first adjusted values in the first storage part to the second storage part so as to replace the current adjusted values with the first adjusted values by means of a simple operation.

### BRIEF DESCRIPTION OF THE DRAWINGS

FIG. 1 is a block diagram that shows the structure of a display device according to a first embodiment.

FIG. 2 is a flowchart that shows an operation of setting manager adjusted values in the first embodiment.

FIG. 3 is a flowchart that shows an operation of setting user adjusted values in the first embodiment.

FIG. 4 is a flowchart that shows an operation of restoring the manager adjusted values according to a manager operation in the first embodiment.

FIG. 5 is a flowchart that shows an operation of restoring the manager adjusted values when a predetermined condition is satisfied in the first embodiment.

FIG. 6 is a block diagram that shows the structure of a display device according to a second embodiment.

FIG. 7 is a flowchart that shows an operation of setting manager adjusted values in the second embodiment.

FIG. 8 is a flowchart that shows an operation of restoring the manager adjusted values when a predetermined condition is satisfied in the second embodiment.

FIG. 9 is a block diagram that shows the structure of a display device according to a third embodiment.

FIG. 10 is a block diagram that shows the structure of a display device according to a third embodiment.

FIG. 11 is a block diagram that shows the structure of a display device according to a fourth embodiment.

FIG. 12 is a block diagram that shows the structure of a display device according to a fifth embodiment.

FIG. 13 is a block diagram that shows the structure of a display device according to a sixth embodiment.

### MODE FOR CARRYING OUT THE INVENTION

### First Embodiment

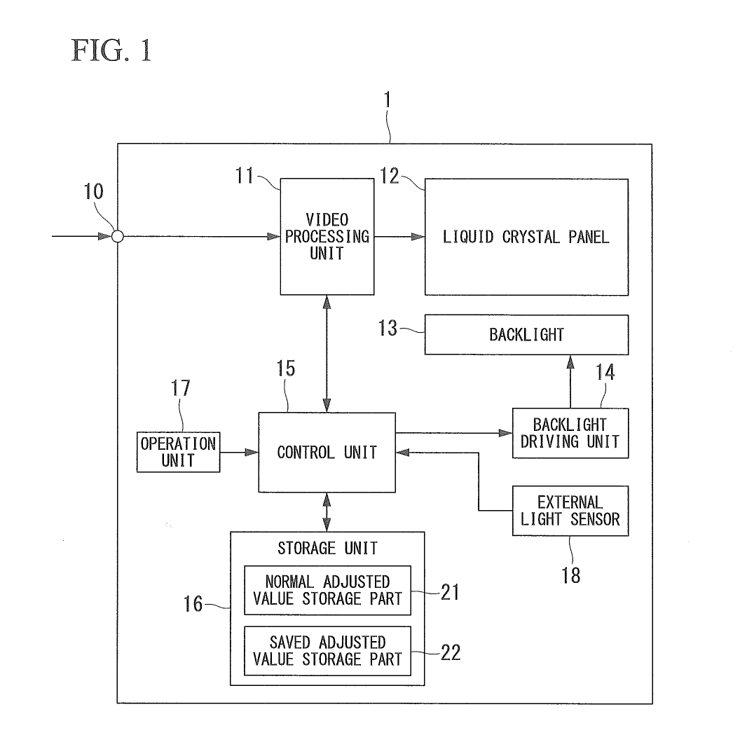

Below, an embodiment of the present invention will be explained in detail with reference to the drawings. FIG. 1 is a block diagram that shows the structure of a display device according to the present embodiment.

As shown in FIG. 1, a display device 1 includes a video processing unit 11, a liquid crystal panel 12, a backlight 13, a backlight driving unit 14, a control unit 15, a storage unit 16, an operation unit 17, and an external light sensor 18.

In FIG. 1, a video signal input from an input terminal is supplied to the video processing unit 11. The video processing unit 11 subjects the input video signal to processes such as image size adjustment, luminance adjustment (for sharpness, brightness, contrast, or the like), and color collection. A signal output from the video processing unit 11 is supplied to the liquid crystal panel 12.

The liquid crystal panel 12 may be formed by interposing an liquid crystal layer, that is made of a liquid crystal composition, between an array substrate, in which TFTs (Thin Film Transistors) or the like are applied to individual pixels, and a color filter substrate. In the color filter substrate, color filters of three primary colors such as red (R), green (G), and blue (B) may be arranged.

The backlight 13 functions as a light source that irradiates the liquid crystal panel 12. An LED (Light Emitting Diode) or a cold cathode-ray tube may be utilized as the backlight 13. The backlight 13 is driven utilizing a driving signal from the backlight driving unit 14.

The control unit 15 controls the general operation of the display device 1. The storage unit 16 and the operation unit 17 are provided pertaining to the control unit 15. The storage unit 16 has a normal adjusted value storage part 21 and a saved adjusted value storage part 22. The external light sensor 18 measures brightness of external light.

The operation unit 17 is utilized to execute the various adjustments such as the luminance adjustment, the color correction, and the image size adjustment. When executing such adjustments, the control unit 15 produces a menu screen which is transferred to the video processing unit 11. The user performs various adjustments such as sharpness, brightness, hue, or the like by operating the operation unit 17 while watching the menu screen. Additionally, in the present embodiment, a manager can adjust individual parts of the video processing unit so as to provide a common environment to the whole target. Each value adjusted by the manager is stored in the saved adjusted value storage part 22.

As described above, in the present embodiment, the storage unit 16 has the normal adjusted value storage part 21 and the saved adjusted value storage part 22 to which user adjusted values and manager adjusted values are respectively stored.

When the user normally uses the display device, the relevant parts can be adjusted utilizing the operation unit 17 as described above. The adjusted values stored in the normal adjusted value storage part 21 are directly effective when the display device 1 is operated. In addition, such stored adjusted values can be replaced with values adjusted by the user.

In contrast, adjusted values stored in the saved adjusted value storage part 22 can be set only by the manager and cannot by updated by the user. If the adjusted values stored in the saved adjusted value storage part 22 are stored in the normal adjusted value storage part 21, the values are effective when the display device 1 is operated.

Such a display device 1 may be preferably utilized as a display introduced to a company or school. That is, displays introduced to a company or school should be subjected to adjustment of individual parts of each display so as to provide a common environment to the whole company or school. However, when each user such as an employee or a student uses the display, it is preferable for the individual user to perform the adjustment again. In the display device 1 of the present embodiment, a manager of a company or school performs adjustment of relevant parts of each display device 1 and stores the adjusted values in the saved adjusted value storage part 22 in advance. Then each user such as an employee or a student uses performs the adjustment of the display device 1 according to the preference of the user and stores the adjusted values in the normal adjusted value storage part 21. Therefore, a common environment can be provided to the whole company or school while each user can use the display device 1 with adjusted values suitable for the user. In addition, the manager can always replace the current adjusted values of the display device 1 with the manager adjusted values by writing the adjusted values stored in the saved adjusted value storage part 22 into the normal adjusted value storage part 21.

Additionally, in the display device 1 of the present embodiment, a condition may be set by which the current adjusted values of the display device 1 can be replaced with the manager adjusted values without a manager's direct operation of restoring the manager adjusted values. In a specific example of restoring the manager adjusted values in the display device 1 of the present embodiment, the above condition is that a power saving mode has been effective for a predetermined period of time or longer. In another example of restoring the manager adjusted values in the display device 1 of the present embodiment, the condition is that a state in which the power saving mode is effective and the external world is dark has been continued for a predetermined period of time or longer.

The power saving mode is a function of reducing power consumption by stopping the display operation while no video is input into the display device. The control unit 15 monitors the presence or absence of a video signal from the video processing unit 11 and makes the power saving mode effective when no video is input so as to reduce the power consumption. In addition, external brightness is measured utilizing the external light sensor 18. When a measured signal output from the external light sensor 18 is less than or equal to a predetermined level, the control unit 15 determines that the external world is dark.

For example, when students of different classes share display devices of a school, it is preferable to restore the manager adjusted values every time the class which uses the display devices is changed. Here, a lot of labor is required if a manager performs an operation to restore the manager adjusted values for each of the display devices every time the class is changed.

In such a case, in the display device 1 of the present embodiment, the current adjusted values can be replaced with the manager adjusted values by, for example, keeping the display device in the power saving mode for a predetermined period of time. The manager adjusted values can also be restored by keeping a state in which the power saving mode is effective and the external world is dark for a predetermined period of time. If the condition such that a state in which the power saving mode is effective and the external world is dark for a predetermined period of time is employed, incorrect setting (or restoring) can be more reliably avoided in comparison that the condition that the power saving mode is effective for a predetermined period of time.

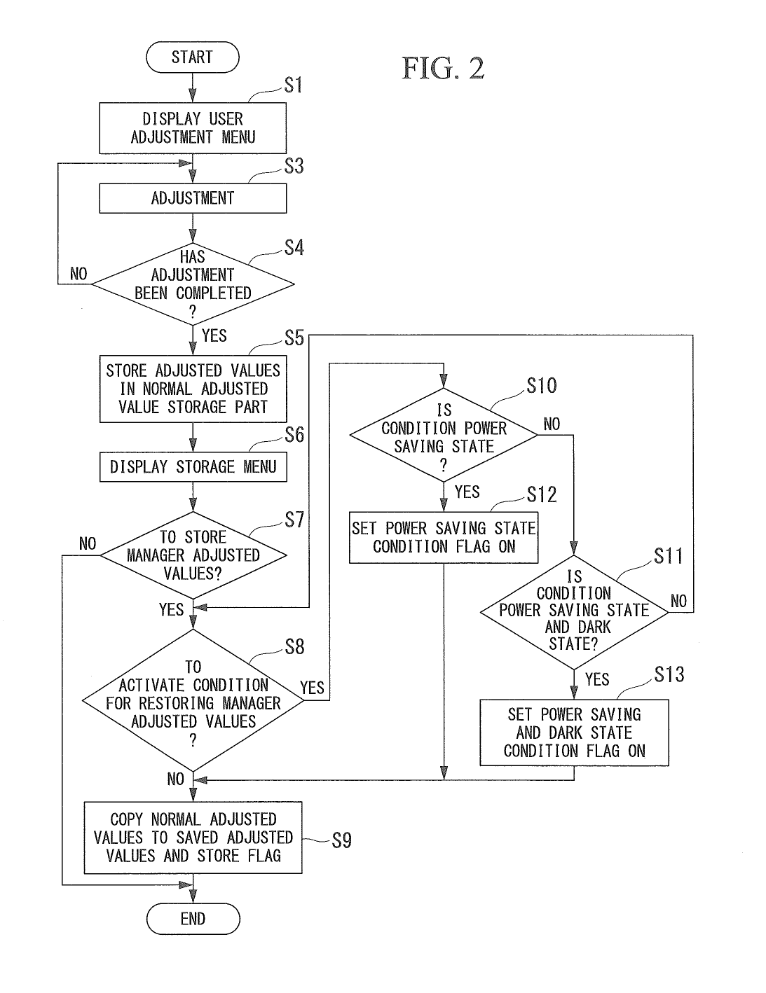

FIG. 2 is a flowchart that shows an operation of setting the manager adjusted values. In FIG. 2, the control unit 15 makes a control to display a user adjustment menu step S1).

The manager adjusts various items such as sharpness, brightness, hue, and the like by operating the operation unit 17 (see step S3). The control unit 15 determines whether or not the adjustment of the items has been completed (see step S4). If the adjustment has not yet been completed (i.e., “NO” in step S4), the operation returns to step S3 so that the manager continues the adjustment.

When it is determined in step S4 that the adjustment has been completed (i.e., “YES” in step S4), the control unit 15 stores the adjusted values in the normal adjusted value storage part 21 (see step S5). The control unit 15 then executes a manager authentication process or the like to display a storage menu (see step S6). The storage menu includes selective items such as “to store or not store manager adjusted values”, “to activate or not activate a condition for restoring manager adjusted values”, “condition for restoring manager adjusted values is power saving state”, and “condition for restoring manager adjusted values is power saving state and dark state”.

The control unit 15 determines whether or not “to store manager adjusted values” has been selected in the storage menu (see step S7). If “to not store manager adjusted values” has been selected (i.e., “NO” in step S7), the operation is terminated here.

If “to store manager adjusted values” has been selected in step S7 (i.e., “YES” in step S7), the control unit 15 further determines whether or not “to activate a condition for restoring manager adjusted values” has been selected (see step S8). If “to not activate a condition for restoring manager adjusted values” has been selected (i.e., “NO” in step S7), the control unit 15 stores all adjusted values, which have been stored in the normal adjusted value storage part 21, in the saved adjusted value storage part 22 (see step S9) and terminates the operation.

If “to activate a condition for restoring manager adjusted values” has been selected in step S8 (i.e., “YES” in step S8), the control unit 15 further determines whether the “condition for restoring manager adjusted values is the power saving state” (see step S10) or the “condition for restoring manager adjusted values is the power saving state and dark state” (see step S11) has been selected.

If it is determined that the “condition for restoring manager adjusted values is the power saving state” is effective in step S10 (i.e., “YES” in step S10), the control unit 15 sets a power saving state condition flag on (see step S12). The control unit 15 then stores all adjusted values of the normal adjusted value storage part 21 in the saved adjusted value storage part 22 and also stores the power saving state condition flag (see step S9). The operation is then terminated.

If it is determined that the “condition for restoring manager adjusted values is the power saving state and dark state” is effective in step S11 (i.e., “YES” in step S11), the control unit 15 sets a power saving and dark state condition flag on (see step S13). The control unit 15 then stores all adjusted values of the normal adjusted value storage part 21 in the saved adjusted value storage part 22 and also stores the power saving state condition flag (see step S9). The operation is then terminated.

As described above, the adjusted values are stored in the saved adjusted value storage part 22 according to the manager adjustment. The data in the saved adjusted value storage part 22 cannot be rewritten through a normal operation. In addition, when a condition for restoring the manager adjusted values has been set, a flag corresponding to the relevant condition is set on.

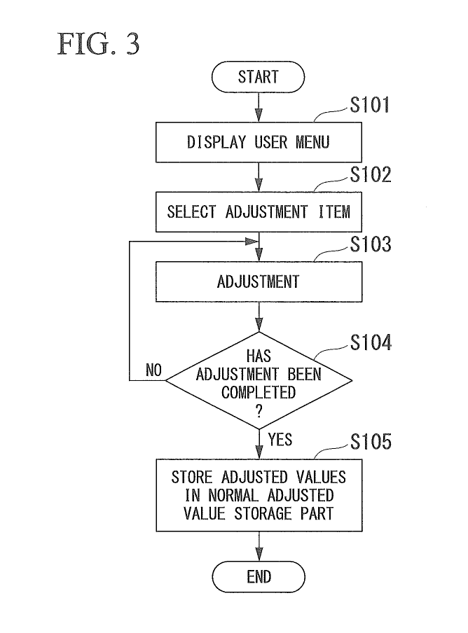

FIG. 3 is a flowchart that shows an operation of setting the user adjusted values. In FIG. 3, the control unit 15 controls the liquid crystal panel 12 to display a user menu that includes an item of setting the user adjusted values (see step S101). The control unit 15 determines whether the user selects a setting item for the user adjustment (see step S102).

When it is determined that a setting item for the user adjustment has been selected in step S102 (i.e., “YES” in step S102), the user performs various adjustments such as sharpness, brightness, hue, or the like by operating the operation unit 17 (see step S103). The control unit 15 then determines whether or not the adjustment of the items has been completed (see step S104). If the adjustment has not yet been completed (i.e., “NO” in step S104), the operation returns to step S103 so that the user continues the adjustment.

When it is determined in step S104 that the adjustment has been completed (i.e., “YES” in step S104), the control unit 15 stores the adjusted values in the normal adjusted value storage part 21 (see step S5) and terminates the operation.

As described above, the adjusted values are stored in the normal adjusted value storage part 21 according to the user adjustment. The data in the normal adjusted value storage part 21 is updated every time the relevant adjustment is executed, and the adjusted values stored in the normal adjusted value storage part 21 are directly effective when the display device 1 is operated.

The user adjusted values stored in the normal adjusted value storage part 21 can be replaced with the manager adjusted values by means of an operation of the manager. When a condition for restoring the manager adjusted values has been set, the user adjusted values stored in the normal adjusted value storage part 21 are replaced with the manager adjusted values if the condition is satisfied.

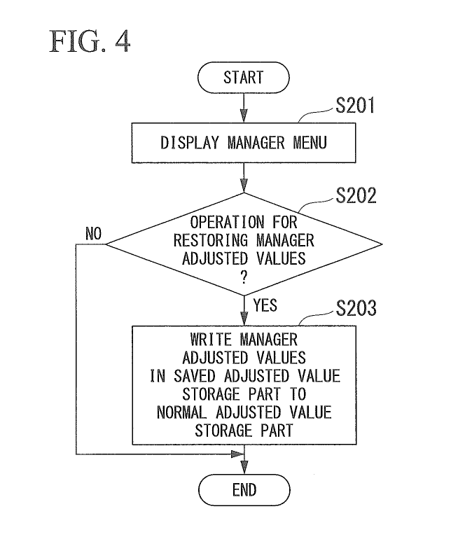

FIG. 4 is a flowchart that shows an operation of replacing the user adjusted values stored in the normal adjusted value storage part 21 with the manager adjusted values according to a manager operation. In FIG. 4, the control unit 15 performs a control to display a manager menu that includes a setting item of restoring the manager adjusted values (see step S201). The control unit 15 determines whether or not an operation for restoring the manager adjusted values has been selected (see step S202). If it is determined that the operation for restoring the manager adjusted values has been selected (i.e., “YES” in step S202), the control unit 15 writes the manager adjusted values in the saved adjusted value storage part 22 to the normal adjusted value storage part 21 (see step S203). In contrast, if it is not determined that the operation for restoring the manager adjusted values has been selected (i.e., “NO” in step S202), the control unit 15 terminates the operation of the present flowchart.

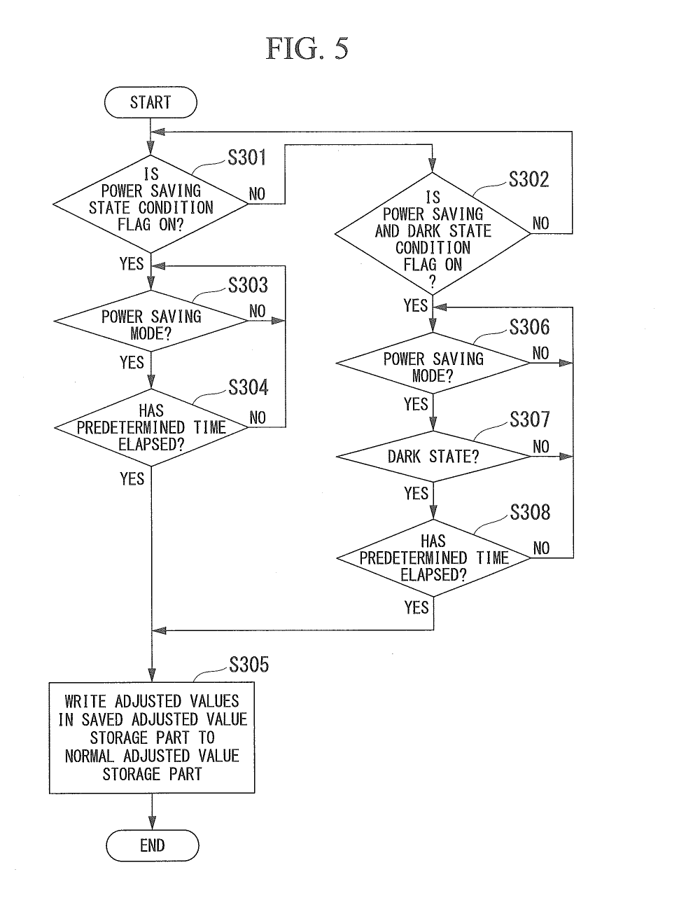

FIG. 5 is a flowchart that shows an operation of replacing the user adjusted values stored in the normal adjusted value storage part 21 with the manager adjusted values when a predetermined condition is satisfied.

In FIG. 5, the control unit 15 determines whether or not the power saving state condition flag has been set on (see step S301) and also determines whether or not the power saving and dark state condition flag has been set on (see step S302).

If the power saving state condition flag has been set on (see step S301), the control unit 15 determines whether or not the power saving mode is effective (see step S303), where the power saving mode is effective when no video signal is input into the video processing unit 11. If the power saving mode is effective (see step S303), it is determined whether or not the power saving mode has continued for a predetermined period of time (see step S304). If the power saving mode has continued for a predetermined period of time (see step S304), the control unit 15 writes the manager adjusted values in the saved adjusted value storage part 22 to the normal adjusted value storage part 21 (see step S305).

If the power saving and dark state condition flag has been set on (see step S302), the control unit 15 determines whether or not the power saving mode is effective (see step S306). If the power saving mode is effective (see step S306), the control unit 15 further determines whether or not the external world is dark (see step S307), where the brightness of the external world is measured utilizing the external light sensor 18. When a measured signal output from the external light sensor 18 is less than or equal to a predetermined level, the control unit 15 determines that the external world is dark. The control unit 15 then determines whether or not the state in which the power saving mode is effective and the external world is dark has continued for a predetermined period of time (see step S308). If the state in which the power saving mode is effective and the external world is dark has continued for a predetermined period of time (see step S308), the control unit 15 writes the manager adjusted values in the saved adjusted value storage part 22 to the normal adjusted value storage part 21 (see step S305) so as to replace the adjusted values in the normal adjusted value storage part 21 with the manager adjusted values (see step S305).

As described above, in the display device of the present embodiment, manager adjusted values utilized to provide a common environment to users can be set by storing the manager adjusted values in the saved adjusted value storage part 22. In addition, user adjusted values according to the preference of each user can be set by storing the user adjusted values in the saved adjusted value storage part 22. Furthermore, in the display device of the present embodiment, the current adjusted values can be replaced with the manager adjusted values by, for example, continuing the power saving mode for a predetermined period of time or continuing the power saving mode and the dark state for a predetermined period of time. Therefore, it is possible to easily replace the user adjusted values with the manager adjusted values.

### Second Embodiment

This embodiment explains an example in which manager adjusted values in the saved adjusted value storage part 22 are written to the normal adjusted value storage part 21 in accordance with a state of a video signal input into the display device, so as to replace adjusted values in the normal adjusted value storage part 21 with the manager adjusted values.

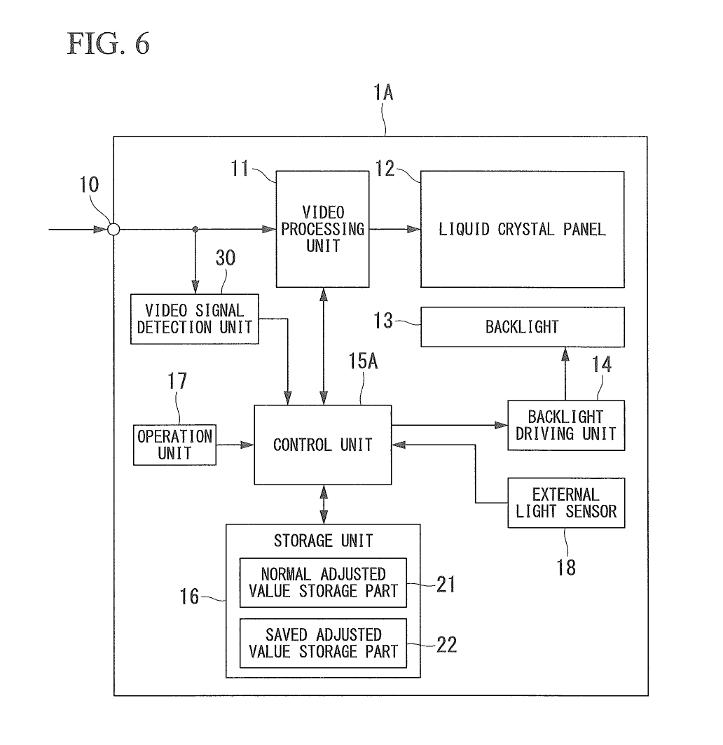

FIG. 6 is a block diagram that shows the structure of a display device 1A according to the present embodiment. As shown in FIG. 6, a display device 1A includes a video processing unit 11, a liquid crystal panel 12, a backlight 13, a backlight driving unit 14, a control unit 15A, a storage unit 16, an operation unit 17, an external light sensor 18, and a video signal detection unit 30. Here, functional units having the same functions as those of the display device 1 explained in the first embodiment are given identical reference numerals and explanations thereof are omitted here.

The video signal detection unit 30 detects that a video signal from the input terminal 10 has been disconnected and outputs a detected result to the control unit 15A. In an example, the video signal detection unit 30 detects that a video signal from the input terminal 10 has been disconnected when a signal output from the input terminal 10 includes no video signal. In another example, the video signal detection unit 30 detects that a video signal from the input terminal 10 has been disconnected when a signal output from the input terminal 10 includes no synchronization signal (horizontal synchronization signal or vertical synchronization signal).

The video signal detection unit 30 also measures the resolution of the video signal input from the input terminal 10. The video signal detection unit 30 detects that the measured resolution has changed and outputs the detected result to the control unit 15A. If the video signal is an analog signal, the video signal detection unit 30 may measure the resolution of the video signal by measuring the number of scanning lines included in the video signal or the scanning frequency. If the video signal is a digital signal, the video signal detection unit 30 may measure the resolution of the video signal by extracting information which is included in header information or the like of the signal and indicates the resolution. In addition, the video signal detection unit 30 may measure the scanning rate of the video signal and detect that the measured scanning rate has changed.

The video signal detection unit 30 also detects that a video cable is inserted into the input terminal 10 or that no video cable is inserted into the input terminal 10. The video signal detection unit 30 outputs the detected result to the control unit 15A. The video signal detection unit 30 may detect that a video cable is inserted into the input terminal 10 by measuring an electric potential of the ground line of the input terminal 10. The video signal detection unit 30 may detect that a video cable is inserted into the input terminal 10 by detecting a phenomenon in which when a video cable is connected, a pulled-up potential varies from a High level to a Low level.

In accordance with a result of the detection by the video signal detection unit 30, the control unit 15A switches the adjusted values from the user adjusted values stored in the normal adjusted value storage part 21 to the manager adjusted values stored in the saved adjusted value storage part 22. For example, when it is detected that the video signal input into the input terminal 10 has been disconnected, the control unit 15A switches the adjusted values from the user adjusted values to the manager adjusted values. In another example, when it is detected that the resolution of the video signal input into the input terminal 10 has changed, the control unit 15A switches the adjusted values from the user adjusted values to the manager adjusted values. In another example, when it is detected that a video cable has been inserted into the input terminal 10 or has been detached from the input terminal 10, the control unit 15A switches the adjusted values from the user adjusted values to the manager adjusted values. Additionally, when a manager operates the operation unit 17 to set a condition utilized to restore the manager adjusted values, the control unit 15A sets a change flag on and stores it in the storage unit 16.

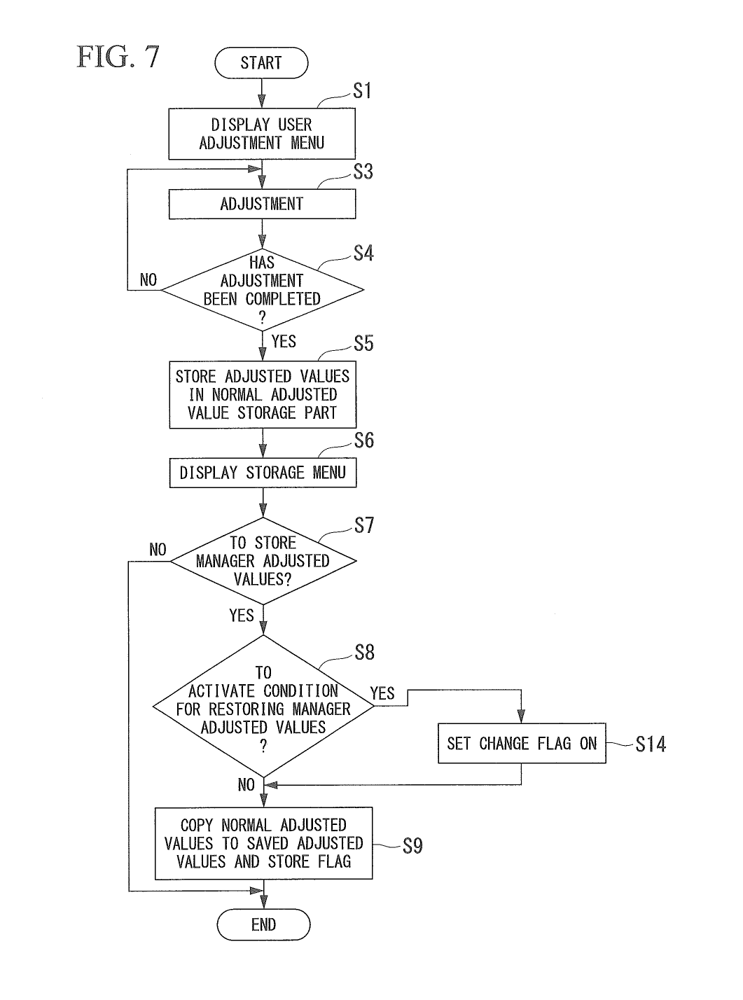

FIG. 7 is a flowchart that shows an operation of setting the manager adjusted values, where the operation from step S1 to step S9 are identical to step S1 to step S9 of the first embodiment (see FIG. 2).

If “to activate a condition for restoring manager adjusted values” has been selected in step S8 (i.e., “YES” in step S8), the control unit 15 sets a change flag on (see step S14) and the operation proceeds to step S9. The change flag is a flag that indicates whether or not the adjusted values are to be changed in accordance with a result detected by the video signal detection unit 30. When the change flag is on, the adjusted values are changed according to a result detected by the video signal detection unit 30. When the change flag is off, the adjusted values are not changed according to a result detected by the video signal detection unit 30.

The operation for setting the user adjusted values is identical to that performed in the first embodiment (see FIG. 3).

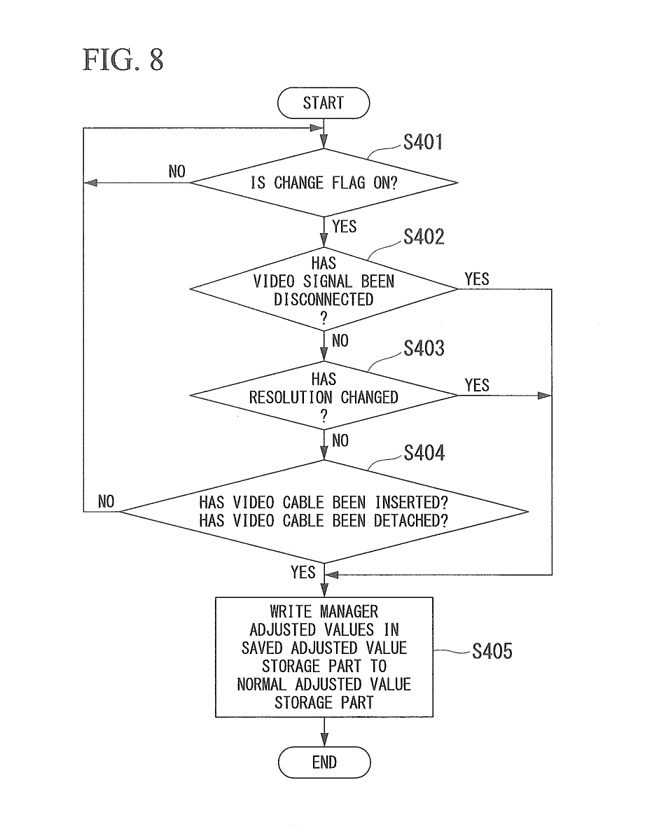

An operation explained below is utilized when a set condition has been satisfied, and the user adjusted values stored in the normal adjusted value storage part 21 are reset to restore the manager adjusted values stored in the saved adjusted value storage part 22. FIG. 8 is a flowchart that indicates an operation of restoring the manager adjusted values when a set condition has been satisfied in the present embodiment.

When the change flag is being set on (see “YES” in step S401), the control unit 15A then executes step S402. When the change flag is not on (i.e., “NO” in step S401), the process of step S401 is repeated.

Based on a result detected by the video signal detection unit 30, the control unit 15A determines whether or not the video signal has been disconnected (see step S402). If it is determined that the video signal has been disconnected (i.e., “YES” in step S402), the control unit 15A then executes step S405. If it is determined that the video signal has not been disconnected (i.e., “YES” in step S402), the operation proceeds to step S403. Based on a result detected by the video signal detection unit 30, the control unit 15A determines whether or not the resolution of the video signal has changed (see step S403). If it is determined that the resolution of the video signal has changed (i.e., “YES” in step S403), the control unit 15A then executes step S405. If it is determined that the resolution of the video signal has not changed (i.e., “NO” in step S403), the operation proceeds to step S404.

Based on a result detected by the video signal detection unit 30, the control unit 15A determines whether or not a video cable has been inserted into the input terminal 10, or whether or not a video cable has been detached from the input terminal 10 (see step S404). If it is determined that a video cable has been inserted into the input terminal 10 or a video cable has been detached from the input terminal 10 (i.e., “YES” in step S404), the control unit 15A then executes step S405. If it is determined that no video cable has been inserted into the input terminal 10 or no video cable has been detached from the input terminal 10 (i.e., “NO” in step S404), the operation returns to step S401.

The control unit 15A writes the manager adjusted values in the saved adjusted value storage part 22 to the normal adjusted value storage part 21 so as to replace the adjusted values in the normal adjusted value storage part 21 with the manager adjusted values (see step S405).

In the following example, a plurality of users commonly use the display device 1A connected to a personal computer. In this case, first, a first user activates the personal computer and sets the user adjusted values for the display device 1A so as to utilize the personal computer and the display device 1A. When finishing use of the personal computer, the first user turns off the power of the personal computer or applies the power saving mode to the personal computer. Accordingly, the video signal input from the personal computer to the display device 1A is disconnected. According to the disconnection of the video signal, the display device 1A switches the adjusted values from the user adjusted values to the manager adjusted values. When a second user activates the personal computer or makes the personal computer return from the power saving mode, the adjusted values of the display device 1A are replaced with the manager adjusted values. Therefore, in accordance with the display device 1A of the present embodiment, the next user can start using the personal computer having the adjusted values set by the manager, regardless of the user adjusted values set by the first user who used the personal computer previously.

Additionally, when the resolution of the video signal input into the display device 1A has changed, it can be estimated that the user of the display device 1A changed and the second user changed the resolution of the video signal output from the personal computer. If a plurality of personal computers are connected to one display device 1A, it can be estimated that the currently used personal computer is switched. Therefore, in the display device 1A of the present embodiment, the adjusted values are switched from the user adjusted values to the manager adjusted values according to a change in the resolution of the input video signal. Accordingly, when the second user stars using the personal computer, the adjusted values of the display device 1A are switched to the manager adjusted values. Therefore, in accordance with the display device 1A of the present embodiment, the next user can start using the personal computer having the adjusted values set by the manager, regardless of the user adjusted values set by the first user who used the personal computer previously.

Also for a case in which a video cable is inserted into or detached from the input terminal 10 of the display device 1A, it can be estimated that the user of the display device 1A has changed. For this case, it can also be estimated that the personal computer connected to the display device 1A has been changed. Therefore, in the display device 1A, the adjusted values are switched from the user adjusted values to the manager adjusted values when a video cable is inserted or detached. Accordingly, when the second user stars using the personal computer, the adjusted values of the display device 1A are switched to the manager adjusted values. Therefore, in accordance with the display device 1A of the present embodiment, the next user can start using the personal computer having the adjusted values set by the manager, regardless of the user adjusted values set by the first user who used the personal computer previously.

In the above-explained example, the device connected to the display device 1A is a personal computer. However, the present invention is not limited to this form. A device that inputs video to the display device may be a medium recording and reproducing device such as an optical disk.

As described above, in the display device 1A of the present embodiment, the adjusted values are switched from the user adjusted values to the manager adjusted values when at least one of the following states occurs: (i) the video signal input into the display device 1A has been disconnected; (ii) the resolution of the input video signal has changed; (ii) a video cable has been inserted; and (iv) a video cable has been detached. Accordingly, in the present embodiment, the manager adjusted values utilizing to provide a common environment to users and the user adjusted values according to the preference of each user can be set, and the user adjusted values can be replaced with the manager adjusted values with a simple operation.

### Third Embodiment

The first embodiment explained an example in which based on a measured signal output from the external light sensor 18, when a state in which the external world is dark has continued for a predetermined period of time, the manager adjusted values in the saved adjusted value storage part 22 are written to the normal adjusted value storage part 21 so as to replace the adjusted values in the normal adjusted value storage part 21 with the manager adjusted values. In the present embodiment, when the user has left the display device and finished the use of the display device, the manager adjusted values in the saved adjusted value storage part 22 are written to the normal adjusted value storage part 21 so as to replace the adjusted values in the normal adjusted value storage part 21 with the manager adjusted values.

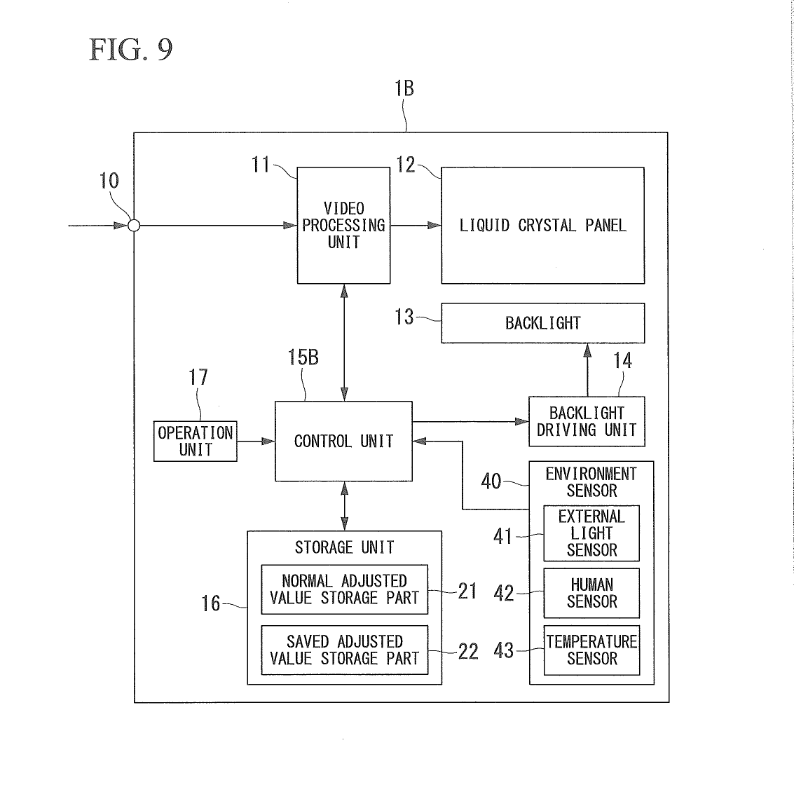

FIG. 9 is a block diagram that shows the structure of a display device 1B according to the present embodiment. As shown in FIG. 9, a display device 1B includes a video processing unit 11, a liquid crystal panel 12, a backlight 13, a backlight driving unit 14, a control unit 15B, a storage unit 16, an operation unit 17, and an environment sensor 40. Here, functional units having the same functions as those of the display device 1 explained in the first embodiment are given identical reference numerals and explanations thereof are omitted here.

The environment sensor 40 includes an external light sensor 41, an human sensor 42, and a temperature sensor 43.

Similar to the external light sensor 18 (see FIG. 1), the external light sensor 41 measures brightness in a room where the display device 1B is disposed and outputs a measurement signal that indicates the measured brightness to the control unit 15B.

The temperature sensor 43 measures temperature and outputs a measurement signal that indicates the measured temperature to the control unit 15B. While the user uses the display device 1B, the temperature sensor 43 measures a temperature which has included due to a surface temperature of the user. In contrast, while the user does not use the display device 1B, the temperature sensor 43 measures a temperature in the room where the display device 1B is disposed.

The human sensor 42 is a sensor utilized to detect a state that a user currently uses the display device 1B or a state that a user currently uses a device connected to the display device 1B. The human sensor 42 may be an infrared sensor, an imaging device, a vibration sensor, a sound collecting device, or a touch panel.

The infrared sensor measures infrared from a user as a heat source and outputs a corresponding measurement signal to the control unit 15B. While the user uses the display device 1B, the infrared sensor measures a surface temperature of the user. In contrast, while the user does not use the display device 1B, the infrared sensor measures a surface temperature of outside air. Here, the surface temperature of outside air may be 20° C. and the surface temperature of the user may be 30° C. The range of the electromagnetic wave measured by the infrared sensor may include a far-infrared region. The infrared sensor may be attached to the front surface of the display device 1B.

The imaging device outputs a captured image to the control unit 15B. While the user uses the display device 1B, the imaging device performs imaging of a region that includes the user's face. In contrast, while the user does not use the display device 1B, the imaging device performs imaging of a region that does not include the user's face. Here, the imaging device may detect far-infrared from the user as a heat source and may be attached to the front surface of the display device 1B.

The vibration sensor outputs a measurement signal as a sensed result to the control unit 15B. While the user uses the display device 1B, the vibration sensor measures a vibration generated when a keyboard or a mouse is operated by the user. In contrast, while the user does not use the display device 1B, the user operates no keyboard or mouse and thus no vibration based on such a device is detected by the vibration sensor. The vibration sensor may be attached to the front surface of the display device 1B.

The sound collecting device outputs a detection signal as a sensed result to the control unit 15B. While the user uses the display device 1B, the sound collecting device detects a signal of sound generated when a keyboard or a mouse is operated by the user or a sound signal of the user's voice. In contrast, while the user does not use the display device 1B, the user operates no keyboard or mouse and thus no sound signal based on such a device or the user's voice is detected by the sound collecting device. The sound collecting device may be attached to the front surface of the display device 1B.

The touch panel detects a user's operation and outputs a corresponding detection signal to the control unit 15B. While the user uses the display device 1B, the touch panel detects a user's operation for a predetermined period of time. In contrast, while the user does not use the display device 1B, the user operates no touch panel and thus no detection signal based on the relevant operation is not sensed during a predetermined period of time. The touch panel may be attached to the front surface of the liquid crystal panel 12.

When determining that the display device 1B is not currently used, the control unit 15B writes the manager adjusted values in the saved adjusted value storage part 22 to the normal adjusted value storage part 21 so as to replace the adjusted values in the normal adjusted value storage part 21 with the manager adjusted values.

When the environment sensor 40 is the external light sensor 41, the control unit 15B determines that the display device 1B is being used if a state in which the measurement signal output from the external light sensor 41 is greater than or equal to a predetermined threshold has continued for a predetermined period of time. In addition, the control unit 15B determines that the display device 1B is not being used if a state in which the measurement signal output from the external light sensor 41 is less than a predetermined threshold has continued for a predetermined period of time.

When the human sensor 42 of the environment sensor 40 is an infrared sensor, the control unit 15B determines that the display device 1B is being used if the measurement signal output from the human sensor 42 is greater than or equal to a predetermined threshold. In addition, the control unit 15B determines that the display device 1B is not being used if the measurement signal output from the human sensor 42 is less than a predetermined threshold.

When the human sensor 42 is an imaging device, the control unit 15B determines that the display device 1B is being used if an image output from the human sensor 42 covers a region that includes the user's face. In addition, the control unit 1513 determines that the display device 1B is not being used if the image output from the human sensor 42 has no region that includes the user's face.

When an image output from the human sensor 42 covers a region that includes the user's face, the control unit 15B may recognize whether or not the image of the included face indicates the face of the manager by utilizing a known image recognition method. If the manager's face has been recognized, the control unit 15B writes the manager adjusted values in the saved adjusted value storage part 22 to the normal adjusted value storage part 21 so as to replace the adjusted values of the normal adjusted value storage part 21 with the manager adjusted values based on a determination that the display device 1B is not currently used by any user.

When the human sensor 42 is a vibration sensor, the control unit 15B determines that the display device 1B is being used if the measurement signal output from the human sensor 42 is greater than or equal to a predetermined threshold. In addition, the control unit 15B determines that the display device 1B is not being used if the measurement signal output from the human sensor 42 is less than a predetermined threshold.

When the human sensor 42 is a sound collecting device, the control unit 15B determines that the display device 1B is being used if the detection signal output from the human sensor 42 is greater than or equal to a predetermined threshold. In addition, the control unit 15B determines that the display device 1B is not being used if the detection signal output from the human sensor 42 is less than a predetermined threshold.

When the human sensor 42 is a touch panel, the control unit 15B determines that the display device 1B is being used if a predetermined state of a signal output from the human sensor 42 has continued for a predetermined period of time. In addition, the control unit 15B determines that the display device 1B is not being used if a predetermined state of a signal output from the human sensor 42 has not continued for a predetermined period of time.

When, the measurement signal output from the temperature sensor 43 is greater than or equal to a predetermined threshold, the control unit 15B determines that the display device 1B is being used. On the contrary, when the measurement signal output from the temperature sensor 43 is less than a predetermined threshold, the control unit 15B determines that the display device 1B is not being used. The threshold for the relevant temperature may be changed in accordance with a season or a set temperature of a room where the display device 1B is disposed.

Similar to the second embodiment, the present embodiment may also perform the above-described process if a change flag is set on in step S14 of the operation for setting the manager adjusted values (see FIG. 7).

As described above, in the display device 1B of the present embodiment, the adjusted values is switched from the user adjusted values to the manager adjusted values if it is determined that the display device 1B is not being used in accordance with a result of measurement utilizing at least one of the external light sensor 41, the human sensor 42, and the temperature sensor 43. Therefore, in the present embodiment, the manager adjusted values utilizing to provide a common environment to users and the user adjusted values according to the preference of each user can be set, and the user adjusted values can be replaced with the manager adjusted values with a simple operation.

### Fourth Embodiment

This embodiment explains an example in which the manager adjusted values in the saved adjusted value storage part 22 are written to the normal adjusted value storage part 21 at a predetermined time, so as to replace the adjusted values in the normal adjusted value storage part 21 with the manager adjusted values.

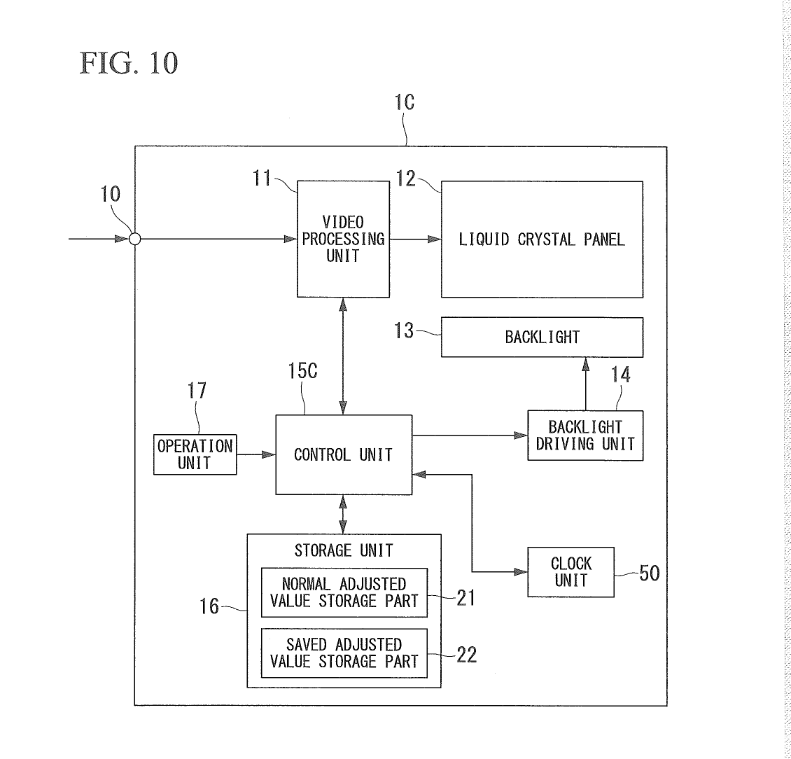

FIG. 10 is a block diagram that shows the structure of a display device 1C according to the present embodiment. As shown in FIG. 10, a display device 1C includes a video processing unit 11, a liquid crystal panel 12, a backlight 13, a backlight driving unit 14, a control unit 15C, a storage unit 16, an operation unit 17, and a clock unit 50. Here, functional units having the same functions as those of the display device 1 explained in the first embodiment are given identical reference numerals and explanations thereof are omitted here.

The clock unit 50 has an oscillation circuit and performs time measurement utilizing a clock signal generated by oscillation of the oscillation circuit, where calendar information is stored in the clock unit 50 in advance. The calendar information is information about year, month, day, and day of week. When a date and a time slot output from the control unit 15C has come, the clock unit 50 outputs date and time information, which indicates that the set date and time has come, to the control unit 15C. In an example, if information which indicates the date and the time slot and is output from the control unit 15C is 8:50 to 9:35 on Monday, then the clock unit 50 outputs the date and time information when 8:50 on Monday has come. If the date and the time slot output from the control unit 15C are those for a class of a school or the like, the clock unit 50 may output the date and time information to the control unit 15C at a time earlier than the set start time. In an example, the clock unit 50 outputs the date and time information to the control unit 15C at 8:49 on Monday, that is, one minute earlier than the set time.

The control unit 15C detects a date and a time slot according to a user's operation utilizing the operation unit 17, where the date and the time are utilized to replace the adjusted values with the manager adjusted values. In an example, when the display device 1C is used in a classroom of a school, the date and the time are set based on a timetable. The control unit 15C outputs information that indicates the detected date and time to the clock unit 50. Here, the information output from the control unit 15C to the clock unit 50 may indicate only a date of week and a start time. In accordance with the date and time information output from the clock unit 50, the control unit 15C writes the manager adjusted values in the saved adjusted value storage part 22 to the normal adjusted value storage part 21 so as to replace the adjusted values in the normal adjusted value storage part 21 with the manager adjusted values.

Next, an example of the operation of the display device 1C will be explained. In this example, the date and time slot for restoring the manager adjusted values are of each language arts class which takes a conscionable time for document watching, specifically, 8:50 to 9:35 on Monday, 9:40 to 10:25 on Tuesday, 13:40 to 14:25 on Wednesday, 11:35 to 12:20 on Thursday, and 10:45 to 11:30 on Friday. In addition, the manager adjusted values are adjusted values set suitable for the language arts class. In this example, the control unit 15C writes the manager adjusted values in the saved adjusted value storage part 22 to the normal adjusted value storage part 21 so as to replace the adjusted values in the normal adjusted value storage part 21 with the manager adjusted values at each of the times of 8:50 on Monday, 9:40 on Tuesday, 13:40 on Wednesday, 11:35 on Thursday, and 10:45 on Friday. Accordingly, for example, a plurality of the display device 1C disposed in a classroom can automatically restore adjusted values which are optimal for the language arts class with no adjustment of the individual display devices by a teacher in charge of the class.

Similar to the second embodiment, the present embodiment may also perform the above-described process if a change flag is set on in step S14 of the operation for setting the manager adjusted values (see FIG. 7).

In the above-described example, the display device is used in a classroom of a school. However, the present invention is not limited thereto. For example, in a showroom, an exhibition, a shop, or the like, the manager adjusted values in the saved adjusted value storage part 22 may be written to the normal adjusted value storage part 21 so as to replace the adjusted values in the normal adjusted value storage part 21 with the manager adjusted values at regular times every day. Additionally, the date and time slot may be set multiple times a day, once a week, once a month, or the like. In addition, the date may be set at regular intervals such as every hour.

The date may be set as a predetermined period of time such as a night hour (e.g., 20:00 to 8:00 in next day). In such a case, the manager adjusted values may have a relatively low luminance. Accordingly, in the display device 1C of the present embodiment, it is possible to reduce the power consumption during night by reducing the luminance in a time slot (e.g., night) which has a low frequency of use.

As explained above, in the display device 1C of the present invention, the adjusted values are switched from the user adjusted values to the manager adjusted values at a date and in a time slot which have been set by the user. Therefore, in the present embodiment, the manager adjusted values utilizing to provide a common environment to users and the user adjusted values according to the preference of each user can be set, and the user adjusted values can be replaced with the manager adjusted values with a simple operation.

### Fifth Embodiment

This embodiment explains an example in which the manager adjusted values in the saved adjusted value storage part 22 are written to the normal adjusted value storage part 21 so as to replace the adjusted values in the normal adjusted value storage part 21 with the manager adjusted values, in accordance with a setting state of the display device.

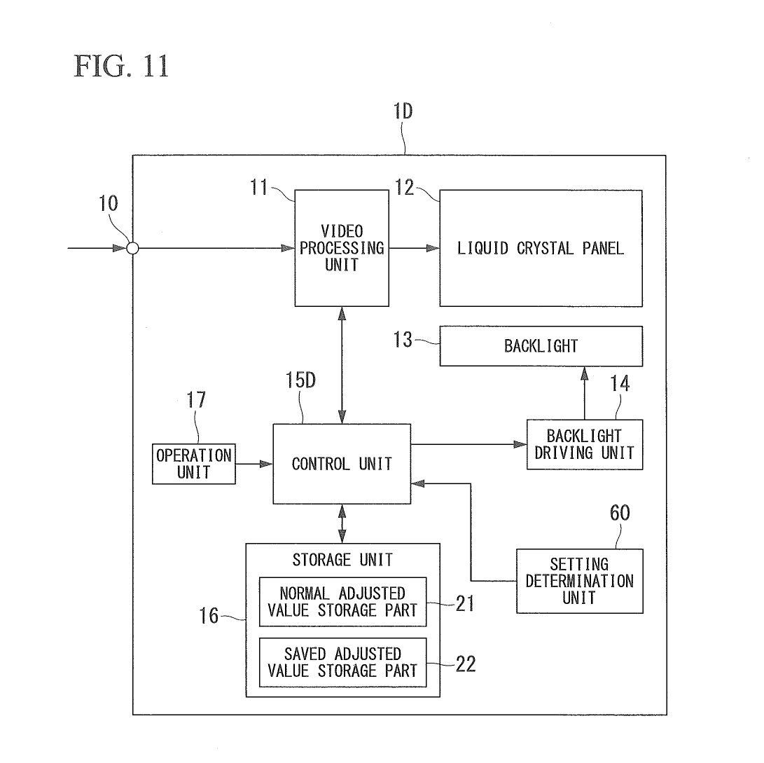

FIG. 11 is a block diagram that shows the structure of a display device 1D according to the present embodiment. As shown in FIG. 11, a display device 1D includes a video processing unit 11, a liquid crystal panel 12, a backlight 13, a backlight driving unit 14, a control unit 15D, a storage unit 16, an operation unit 17, and a setting determination unit 60. Here, functional units having the same functions as those of the display device 1 explained in the first embodiment are given identical reference numerals and explanations thereof are omitted here.

The liquid crystal panel 12 of the present embodiment has adjustable items such as rotation, tilt, height, and swivel. The “tilt” is a function of adjusting the tilt angle of the liquid crystal panel 12. The “swivel” is a function of directing the liquid crystal panel 12 right and left without moving a stage to which the liquid crystal panel 12 is attached.

The setting determination unit 60 includes a triaxial acceleration sensor. Based on a value output from the triaxial acceleration sensor, the setting determination unit 60 determines that the position of the liquid crystal panel 12 of the display device 1D has been rotated and switched from a vertical position to a horizontal position. The setting determination unit 60 outputs a determined result to the control unit 15D. Here, if the resolution of the liquid crystal panel 12 is defined as 1920 horizontal pixels and 1080 vertical pixels, the vertical position is obtained by rotating the liquid crystal panel 12 to have a vertically long arrangement formed by 1920 vertical pixels and 1080 horizontal pixels. In addition, the horizontal position is obtained by rotating the liquid crystal panel 12 to have a horizontally long arrangement formed by 1920 horizontal pixels and 1080 vertical pixels.

The setting determination unit 60 also determines based on a value output from the triaxial acceleration sensor that the tilt of the liquid crystal panel 12 has been adjusted and outputs a determined result to the control unit 15D. Similarly, the setting determination unit 60 determines based on a value output from the triaxial acceleration sensor that the height of the liquid crystal panel 12 has been adjusted and outputs a determined result to the control unit 15D. Furthermore, the setting determination unit 60 determines based on a value output from the triaxial acceleration sensor that the swivel of the liquid crystal panel 12 has been adjusted and outputs a determined result to the control unit 15D.

The setting determination unit 60 may include a mechanical switch. Based on a signal output from the mechanical switch, the setting determination unit 60 may determine that the rotation, tilt, height, or swivel of the liquid crystal panel 12 has been adjusted. Additionally, even when the display device 1D has been moved, it is estimated that the user of the display device 1D has been switched. Therefore, the setting determination unit 60 may determine that the display device 1D has been moved based on a signal output from a mechanical switch or the like.

According to a determination result output from the setting determination unit 60, the control unit 15D determines whether or not any one of the rotation, tilt, height, and swivel of the liquid crystal panel 12 has been adjusted. When one of the rotation, tilt, height, and swivel of the liquid crystal panel 12 has been adjusted, the control unit 15D writes the manager adjusted values in the saved adjusted value storage part 22 to the normal adjusted value storage part 21 so as to replace the adjusted values in the normal adjusted value storage part 21 with the manager adjusted values.

In an estimated example, after a first user performs graphic processing with the liquid crystal panel 12 in the horizontal position, a second user rotates the liquid crystal panel 12 and performs text-editing processing with the liquid crystal panel 12 in the vertical position. Therefore, when the user of the liquid crystal panel 12 is switched, the liquid crystal panel 12 may be rotated. Similarly, when any one of the tilt, height, and swivel of the liquid crystal panel 12 has been adjusted, it is estimated that the user of the display device 1D has been switched.

Accordingly, in the present embodiment, when any one of the rotation, tilt, height, and swivel of the liquid crystal panel 12 has been adjusted, the manager adjusted values in the saved adjusted value storage part 22 are written to the normal adjusted value storage part 21 so as to replace the adjusted values in the normal adjusted value storage part 21 with the manager adjusted values. Therefore, in the display device 1D of the present embodiment, regardless of the user adjusted values set by the first user who previously used the device, the next user can start the use of the device with the adjusted values set by the manager.

Similar to the second embodiment, the present embodiment may also perform the above-described process if a change flag is set on in step S14 of the operation for setting the manager adjusted values (see FIG. 7). Furthermore, in accordance with a usage environment, the manager may operate the operation unit 17 to set whether or not the switching of the adjusted values is to be executed every time it is determined that the rotation, tilt, height, or swivel has been adjusted.

As explained above, in the display device 1D of the present invention, when any one of the rotation, tilt, height, and swivel of the liquid crystal panel 12 has been adjusted, the adjusted values are switched from the user adjusted values to the manager adjusted values. Therefore, in the present embodiment, the manager adjusted values utilizing to provide a common environment to users and the user adjusted values according to the preference of each user can be set, and the user adjusted values can be replaced with the manager adjusted values with a simple operation.

### Sixth Embodiment

This embodiment explains an example in which when power supplied to the display device is interrupted or supplied, the manager adjusted values in the saved adjusted value storage part 22 are written to the normal adjusted value storage part 21 so as to replace the adjusted values in the normal adjusted value storage part 21 with the manager adjusted values.

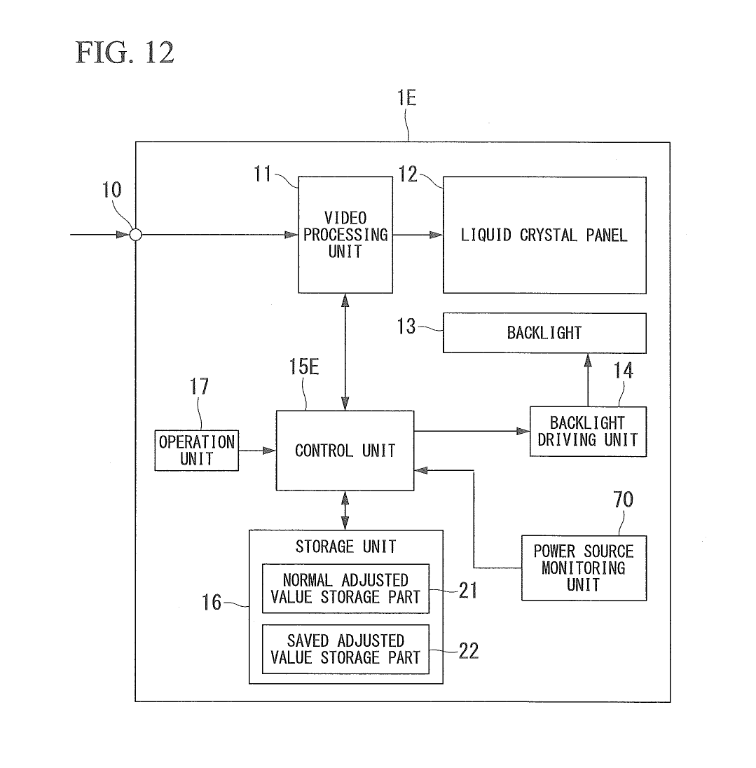

FIG. 12 is a block diagram that shows the structure of a display device 1E according to the present embodiment. As shown in FIG. 12, a display device 1E includes a video processing unit 11, a liquid crystal panel 12, a backlight 13, a backlight driving unit 14, a control unit 15E, a storage unit 16, an operation unit 17, and a power source monitoring unit 70. Here, functional units having the same functions as those of the display device 1 explained in the first embodiment are given identical reference numerals and explanations thereof are omitted here.

The display device 1E of the present embodiment has a power source and a battery which are not shown. The power source supplies power to the individual units in FIG. 12. When the power from the power source is interrupted, the battery supplies electric power to the control unit 15E and the storage unit 16. The battery may be a capacitor having a large capacity. While the power source supplies power to the individual units, the capacitor is charged with the power.

The power source monitoring unit 70 may detect that the power from the power source has been interrupted by pulling out the relevant plug. The power source monitoring unit 70 outputs a detected result (that indicates the interruption) to the control unit 15E. In addition, when detecting that the power from the power source has been interrupted, the power source monitoring unit 70 performs a switching so that power is supplied from the battery to the control unit 15E and the storage unit 16. Here, the above interruption of the power from the power source excludes a case in which the user turns off the display device.

According to the detected result output from the power source monitoring unit 70, the control unit 15E writes the manager adjusted values in the saved adjusted value storage part 22 to the normal adjusted value storage part 21 so as to replace the adjusted values in the normal adjusted value storage part 21 with the manager adjusted values when the power from the power source has been interrupted.

When the power supplied to the display device 1E is interrupted or power supply to the display device 1E is started, it is estimated that a new user starts using the display device 1E. In another estimated case, a manager operates a power source switch provided at a table tap to which a power source plug of the display device 1E is connected, so as to interrupt the power supplied to the display device 1E for power saving.

Therefore, in the display device 1E of the present embodiment, when power from the power source is interrupted or power supply to the display device 1E is started, the manager adjusted values in the saved adjusted value storage part 22 are written to the normal adjusted value storage part 21 so as to replace the adjusted values in the normal adjusted value storage part 21 with the manager adjusted values. Therefore, in the display device 1E of the present embodiment, regardless of the user adjusted values set by the first user who previously used the device, the next user can start the use of the device with the adjusted values set by the manager.

In the above-described example, the power source monitoring unit 70 detects that the power from the power source has been interrupted. However, the present invention is not limited thereto. For example, the power source monitoring unit 70 may detect that an AC plug has been inserted so as to supply power to the power source of the device. In this case, when power is supplied to the power source of the device, the control unit 15E writes the manager adjusted values in the saved adjusted value storage part 22 to the normal adjusted value storage part 21 according to a detected result output from the power source monitoring unit 70, so as to replace the adjusted values in the normal adjusted value storage part 21 with the manager adjusted values.

As explained above, in the display device 1E of the present invention, when power supplied to the display device 1E has been interrupted or the relevant power supply has been started, the adjusted values are switched from the user adjusted values to the manager adjusted values. Therefore, in the present embodiment, the manager adjusted values utilizing to provide a common environment to users and the user adjusted values according to the preference of each user can be set, and the user adjusted values can be replaced with the manager adjusted values with a simple operation.

When the display device 1E explained in the present embodiment is applied to a projector, the projector includes a capacitor having a large capacity so as to secure power required to cool the projector even after the power is interrupted. More specifically, after the power which has been supplied is interrupted, the projector rotates a fan utilizing the power stored in the capacitor having the large capacity, so as to perform the cooling. It is also possible that the projector detects that the power supply has been interrupted and utilizes the power stored in the capacitor having the large capacity to write the manager adjusted values in the saved adjusted value storage part 22 to the normal adjusted value storage part 21 so as to replace the adjusted values in the normal adjusted value storage part 21 with the manager adjusted values.

### Seventh Embodiment

This embodiment explains an example in which when the display device has received a command from an external device, the manager adjusted values in the saved adjusted value storage part 22 are written to the normal adjusted value storage part 21 so as to replace the adjusted values in the normal adjusted value storage part 21 with the manager adjusted values.

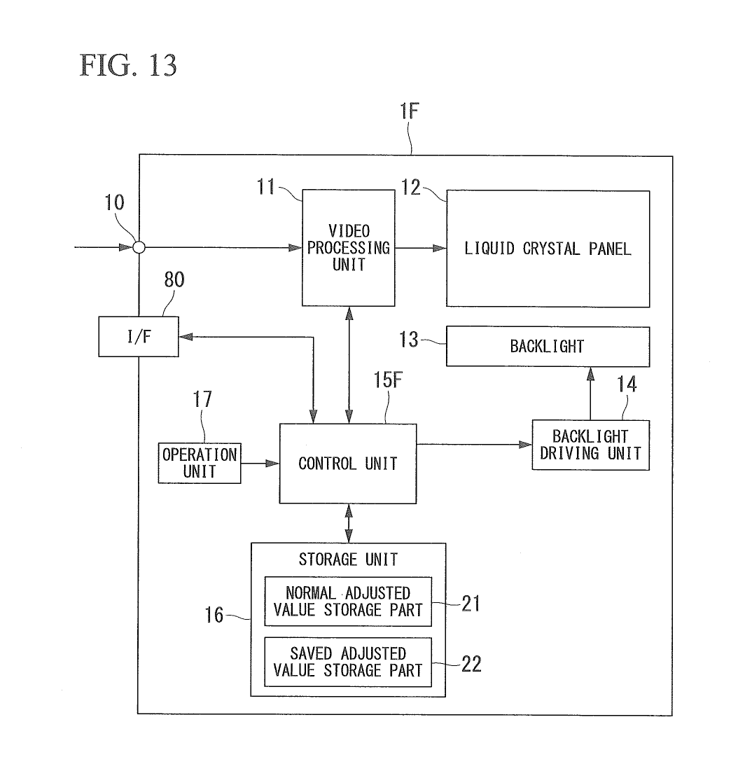

FIG. 13 is a block diagram that shows the structure of a display device 1F according to the present embodiment. As shown in FIG. 12, a display device 1F includes a video processing unit 11, a liquid crystal panel 12, a backlight 13, a backlight driving unit 14, a control unit 15F, a storage unit 16, an operation unit 17, and an I/F 80 (interface). Here, functional units having the same functions as those of the display device 1 explained in the first embodiment are given identical reference numerals and explanations thereof are omitted here.

The I/F 80 is an interface for a radio network, a wired network, optical communication, communication utilizing RF (radio frequency) tags, or the like and includes a communication functional part for any communication network. The I/F 80 receives a command from an external device and outputs the received command to the control unit 15F. The radio network may be a short-distance radio communication network. The wired network may be an IP network, an LAN (Local Area Network), or the like. The optical communication may be infrared communication. In the communication utilizing RF tags, short-distance radio communication utilizing an electromagnetic world or radio waves is performed in accordance with an RF tag in which identification information is embedded.

For example, a manager of the display device 1F transmits a command utilized to restore the manager adjusted values via a radio network or a wired network to the display device 1F by means of a personal computer, a tablet, or the like, that is dedicated to the relevant management. In another example, the manager transmits a command utilized to restore the manager adjusted values via optical communication to the display device 1F by means of a tablet, a portable terminal, or the like, that is dedicated to the relevant management. In another example, the manager transmits a command utilized to restore the manager adjusted values via communication utilizing RF tags to the display device 1F by means of a tablet, a portable terminal, or the like, in which an RF tag for the management is embedded.

In accordance with the command output from the I/F 80, the control unit 15F writes the manager adjusted values in the saved adjusted value storage part 22 to the normal adjusted value storage part 21 so as to replace the adjusted values in the normal adjusted value storage part 21 with the manager adjusted values.

For example, the manager operates a personal computer to transmit the relevant command to a plurality of the display devices 1F connected to a radio network or a wired network. The control unit 15F of each display device 1F switches the current adjusted values to the manager adjusted values according to the command received by the corresponding I/F 80. Therefore, in the present embodiment, the adjusted values of the plurality of the display devices 1F which may be installed in a meeting room of a company or a classroom of a school can be simultaneously replaced with the manager adjusted values.

In addition, when the manager who carries a tablet having an optical communication function or an RF tag makes the rounds of the plurality of the display devices 1F installed in the meeting room of the company or the classroom of the school, it is possible to sequentially switch the adjusted values of each of the display devices 1F to the manager adjusted values.

As explained above, in the display device 1F of the present invention, when a specific command is received from an external device, the adjusted values are switched from the user adjusted values to the manager adjusted values. Therefore, in the present embodiment, the manager adjusted values utilizing to provide a common environment to users and the user adjusted values according to the preference of each user can be set, and the user adjusted values can be replaced with the manager adjusted values with a simple operation.

The first to seventh embodiments provided an example in which the display devices (1 to IF) installed in a classroom or the like were explained as examples. However, the present invention is not limited thereto. The display devices (1 to IF) may be projectors, tablets, portable terminals (e.g., smartphones), or the like.

Additionally, the display devices (1 to 1F) should have at least one of the functions explained in the first to seventh embodiments and may have multiple functions among them. In an example, the display device 1C may include a video signal detection unit 30 (see FIG. 6).

The first to seventh embodiments provided another example in which the user adjusted values are stored in the normal adjusted value storage part 21, and the manager adjusted values arrangement stores in the saved adjusted value storage part 22. However, the present invention is not limited thereto. The adjusted values stored in the normal adjusted value storage part 21 are not limited to those for the luminance, the contrast, the sharpness, the brightness, the hue, and the like and set values pertaining to each functional unit in the display device (among devices 1 to 1F) adjusted by the user may also be stored. Similarly, the adjusted values stored in the saved adjusted value storage part 22 are not limited to those for the luminance, the contrast, the sharpness, the brightness, the hue, and the like and set values pertaining to each functional unit in the display device (among devices 1 to 1F) adjusted by the manager may also be stored.

The first to seventh embodiments provided another example in which the manager adjusted values stored in the saved adjusted value storage part 22 relate to a signal manager. However, the present invention is not limited thereto. If there are a plurality of manager, multiple sets of the manager adjusted values may be stored in the saved adjusted value storage part 22. In this case, the control unit (in one of devices 1 to 1F) may refer to a command from an external device (as explained in the seventh embodiment) to select the manager adjusted values associated with a designated manager among the stored multiple sets of the manager adjusted values. In another example, the control unit (in one of devices 1 to 1F) extracts an identifier, which is included in information received from an RF tag embedded in a tablet or the like carried by a manager and is utilized to identify the manager, and selects the manager adjusted values associated with the extracted identifier.

In addition, although the first embodiment provided an example in which the external light sensor 18 is included in the display device 1 includes, the external light sensor 18 may be an external device. In this case, based on a measurement signal output from the external light sensor 18 as the external device, the display device 1 may perform the above-described control. Similarly, the environment sensor 40, the clock unit 50, the setting determination unit 60, and the power source monitoring unit 70 explained in the second to seventh embodiments may each be an external device.

A program for executing all or part of the functions of the control units 15 to 15F may be stored in a computer readable storage medium, and the program stored in the storage medium may be loaded and executed on a computer system, so as to perform the operation of each unit. Here, the computer system has hardware resources which include an OS and peripheral devices.

If the computer system employs a WWW system, the computer system can provide a homepage service (or viewable) environment.

The above computer readable storage medium is a storage device, for example, a portable medium such as a flexible disk, a magneto optical disk, a ROM, or a CD-ROM, or a memory device such as a hard disk built in a computer system. The computer readable storage medium also covers (i) a device for dynamically storing the program for a short time, such as a communication line used when sending the program via a network (e.g., the Internet) or a communication line (e.g., a telephone line), (ii) or a device for temporarily storing the program, such as a volatile storage medium in a computer system which functions as a server or client for such a program transmission. In addition, the program may execute part of the above-explained functions, or may be a program by which the above-described functions can be executed by a combination program of this program and an existing program which has already been stored in the relevant computer system.

The embodiments of the present invention have been explained in detail with reference to the drawings. However, concrete structures are not limited to the embodiments and also include design modifications or the like, within the scope of the present invention.

Although all or part of the above-described embodiment can be described as follows, the present invention is not limited to the following.

### Supplementary Note 1

A display device comprising:
an operation unit for adjusting a video processing unit;
a saved adjusted value storage part that stores manager adjusted values set in accordance with an operation utilizing the operation unit that is operated by a specific manager;
a normal adjusted value storage part that stores user adjusted values set in accordance with an operation utilizing the operation unit that is operated by any user; and
a control unit that writes the manager adjusted values in the saved adjusted value storage part to the normal adjusted value storage part so as to replace the adjusted values in the normal adjusted value storage part with the manager adjusted values.

### Supplementary Note 2

The display device in accordance with Supplementary note 1, wherein:
the control unit writes the manager adjusted values in the saved adjusted value storage part to the normal adjusted value storage part so as to replace the adjusted values in the normal adjusted value storage part with the manager adjusted values in accordance with a specific condition.

### Supplementary Note 3

A method of adjusting a display device, the method comprising the steps of:
storing manager adjusted values in a saved adjusted value storage part, which have been set in accordance with an operation utilizing an operation unit that is operated by a specific manager;
storing user adjusted values in a normal adjusted value storage part, which have been set in accordance with an operation utilizing the operation unit that is operated by any user; and
writing the manager adjusted values in the saved adjusted value storage part to the normal adjusted value storage part so as to replace the adjusted values in the normal adjusted value storage part with the manager adjusted values.

### Supplementary Note 4

A display device comprising:
a first storage unit that stores first adjusted values;
a second storage unit that stores second adjusted values; and
a control unit that determines, while power of the display device is on, whether or not a predetermined specific condition has been set, where if the specific condition has been set, the control unit executes a process of writing the first adjusted values stored in the first storage unit to the second storage unit according to the specific condition so as to switch the adjusted values pertaining to individual units of the display device to the first adjusted values.

### Supplementary Note 5

The display device in accordance with Supplementary note 4, wherein:
the specific condition is whether or not a usage state of the display device has changed; and
the control unit determines whether or not the usage state of the display device has changed and executes the process if it is determined that the usage state of the display device has changed.

### Supplementary Note 6

The display device in accordance with Supplementary note 4 or 5, wherein:
the specific condition is whether or not a power saving mode has been effective for a predetermined period of time or longer; and
the control unit determines whether or not the power saving mode has been effective for the predetermined period of time or longer and executes the process if it is determined that the power saving mode has been effective for the predetermined period of time or longer.

### Supplementary Note 7

The display device in accordance with Supplementary note 4 or 5, wherein:
the specific condition is whether or not a power saving mode and an externally dark state have been continued for a predetermined period of time or longer; and
the control unit executes the process when determining that the power saving mode and the externally dark state have been continued for the predetermined period of time or longer.

### Supplementary Note 8

The display device in accordance with any one of Supplementary notes 4 to 7, wherein:
the specific condition is at least one of whether or not a video signal input into the display device has been disconnected, whether or not a resolution of the video signal has changed, whether or not a video cable to be connected to the display device has been inserted, and whether or not the video cable has been detached; and
the control unit executes the process when at least one of the following conditions is satisfied: the video signal input into the display device has been disconnected; the resolution of the video signal has changed; the video cable to be connected to the display device has been inserted; and the video cable has been detached.

### Supplementary Note 9

The display device in accordance with any one of Supplementary notes 4 to 8, wherein:
the specific condition is at least one of whether or not use of the display device has been finished and whether or not a user of the display device has been switched; and
the control unit executes the process when at least one of the following conditions is satisfied: the use of the display device has been finished and the user of the display device has been switched.

### Supplementary Note 10

The display device in accordance with any one of Supplementary notes 4 to 9, wherein:
the specific condition is whether or not a predetermined time has come; and
the control unit executes the process if the predetermined time has come.

### Supplementary Note 11

The display device in accordance with any one of Supplementary notes 4 to 10, wherein:
the specific condition is whether or not a setting state of the display device has changed; and
the control unit executes the process if the setting state of the display device has changed.

### Supplementary Note 12

The display device in accordance with any one of Supplementary notes 4 to 11, wherein:
the specific condition is whether or not power supplied to the display device has been disconnected or supply of the power has been started except that a user of the display device has turned off the device; and
the control unit executes the process if the power supplied to the display device has been disconnected or the supply of the power has been started except that the user has turned off the device.

### Supplementary Note 13

The display device in accordance with any one of Supplementary notes 4 to 12, wherein:
the specific condition is whether or not the display device has received a command from an external device; and
the control unit executes the process if the display device has received the command from the external device.

### Supplementary Note 14

A method of adjusting a display device, the method comprising:
a step that stores first adjusted values in a first storage unit;
a step that stores second adjusted values in a second storage unit; and
a step that determines, while power of the display device is on, whether or not a predetermined specific condition has been set, where if the specific condition has been set, the control step executes a process of writing the first adjusted values stored in the first storage unit to the second storage unit according to the specific condition so as to switch the adjusted values pertaining to individual steps of the display device to the first adjusted values.

### REFERENCE SYMBOLS

1, 1A to 1F display device

11 video processing unit

12 liquid crystal panel

13 backlight

15, 15A to 15F control unit

16 storage unit

17 operation unit

18, 41 external light sensor

21 normal adjusted value storage part

22 saved adjusted value storage part

30 video signal detection unit

40 environment sensor

42 human sensor

43 temperature sensor

50 clock unit

60 setting determination unit

70 power source monitoring unit

80 I/F

1. A display device comprising:
a first storage unit that stores first adjusted values;
a second storage unit that stores second adjusted values; and
a control unit that determines, while power of the display device is on, whether or not a predetermined specific condition has been set, where if the specific condition has been set, the control unit executes a process of writing the first adjusted values stored in the first storage unit to the second storage unit according to the specific condition so as to switch the adjusted values pertaining to individual units of the display device to the first adjusted values.

2. The display device in accordance with claim 1, wherein:
the specific condition comprises whether or not a usage state of the display device has changed; and
the control unit determines whether or not the usage state of the display device has changed and executes the process if it is determined that the usage state of the display device has changed.

3. The display device in accordance with claim 1, wherein:
the specific condition comprises whether or not a power saving mode has been effective for a predetermined period of time or longer; and
the control unit determines whether or not the power saving mode has been effective for the predetermined period of time or longer and executes the process if it is determined that the power saving mode has been effective for the predetermined period of time or longer.

4. The display device in accordance with claim 1, wherein:
the specific condition comprises whether or not a power saving mode and an externally dark state have been continued for a predetermined period of time or longer; and
the control unit executes the process when determining that the power saving mode and the externally dark state have been continued for the predetermined period of time or longer.

5. The display device in accordance with claim 1, wherein:
the specific condition comprises at least one of whether or not a video signal input into the display device has been disconnected, whether or not a resolution of the video signal has changed, whether or not a video cable to be connected to the display device has been inserted, and whether or not the video cable has been detached; and
the control unit executes the process when at least one of the following conditions is satisfied: the video signal input into the display device has been disconnected; the resolution of the video signal has changed; the video cable to be connected to the display device has been inserted; and the video cable has been detached.

6. The display device in accordance with claim 1, wherein:
the specific condition comprises at least one of whether or not use of the display device has been finished and whether or not a user of the display device has been switched; and
the control unit executes the process when at least one of the following conditions is satisfied: the use of the display device has been finished and the user of the display device has been switched.

7. The display device in accordance with claim 1, wherein:
the specific condition comprises whether or not a predetermined time has come; and
the control unit executes the process if the predetermined time has come.

8. The display device in accordance with claim 1, wherein:
the specific condition comprises whether or not a setting state of the display device has changed; and
the control unit executes the process if the setting state of the display device has changed.

9. The display device in accordance with claim 1, wherein:
the specific condition comprises whether or not power supplied to the display device has been disconnected or supply of the power has been started except that a user of the display device has turned off the device; and
the control unit executes the process if the power supplied to the display device has been disconnected or the supply of the power has been started except that the user has turned off the device.

10. The display device in accordance with claim 1, wherein:
the specific condition comprises whether or not the display device has received a command from an external device; and
the control unit executes the process if the display device has received the command from the external device.

11. A method of adjusting a display device, the method comprising:
storing first adjusted values in a first storage unit;
storing second adjusted values in a second storage unit; and
determining while power of the display device is on, whether or not a predetermined specific condition has been set, where if the predetermined specific condition has been set, controlling execution of a process of writing the first adjusted values stored in the first storage unit to the second storage unit according to the predetermined specific condition so as to switch the adjusted values pertaining to individual steps of the display device to the first adjusted values.
